(19) United States
(12) Patent Application Publication
(10) Pub. No.: US 2018/0241323 A1
(43) Pub. Date: Aug. 23, 2018

(54) Systems, Devices, and/or Methods for Managing Loads

(71) Applicant: Joey B. Davis, Flint, MI (US)

(72) Inventor: Joey B. Davis, Flint, MI (US)

(21) Appl. No.: 15/437,350

(22) Filed: Feb. 20, 2017

(51) Int. Cl. H02N 15/00; B65D 88/12; B65D 88/02

(52) U.S. Cl. CPC H02N 15/00; B65D 88/022; B65D 88/12

(57) ABSTRACT

Certain exemplary embodiments can provide a method, which comprises causing a cage to be coupled to a first load container and a second load container. The first load container comprises a first neodymium magnet. The second load container comprises a second neodymium magnet. Wherein magnetic repulsion of the first neodymium magnet and the second neodymium magnet maintain a separation between the first load container and the second load container.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is sectional cut-away end view of an exemplary embodiment of a system 1000;

FIG. 2 is a pair of views of an exemplary embodiment of a system 2000;

FIG. 3 is a sectional view of an exemplary embodiment of a system 3000;

FIG. 4 is a plan view of an exemplary embodiment of a system 4000;

FIG. 5 is a perspective view of an exemplary embodiment of a system 5000;

FIG. 6 is a plan view of an exemplary embodiment 6000 of a load container Type 1;

FIG. 7 is a side view of an exemplary embodiment 7000 of a load container Type 1;

FIG. 8 is an end view of an exemplary embodiment 8000 of a load container Type 1;

FIG. 9 is a sectional view of an exemplary embodiment 9000 of a load container Type 1;

FIG. 10 is a sectional view of an exemplary embodiment 10000 of a load container Type 1;

FIG. 11 shows three views of an exemplary embodiment 10000 of a container lid;

FIG. 12 is a set of seven views of an exemplary embodiment 12000 of a load container Type 3;

FIG. 13 is a pair of exploded views of an exemplary embodiment of container assemblies 13000;

FIG. 14 is an exploded view of an exemplary embodiment of a container assembly 14000;

FIG. 15 is a pair of views of an exemplary embodiment of a system 15000;

FIG. 16 is a set of three views of an exemplary embodiment of an aviation deck base mount 16000; and

FIG. 17 is a flowchart of an exemplary embodiment of a method 17000.

### DETAILED DESCRIPTION

Certain exemplary embodiments can provide a method, which comprises causing a cage to be coupled to a first load container and a second load container. The first load container comprises a first neodymium magnet. The second load container comprises a second neodymium magnet. Wherein magnetic repulsion of the first neodymium magnet and the second neodymium magnet maintain a separation between the first load container and the second load container.

Certain exemplary embodiments provide devices, systems, and/or methods usable by the automotive industry. Certain exemplary embodiments rely upon a principal that a size of neodymium magnets does not proportionally correlate to their energy capacities.

In certain exemplary embodiments, an automobile engine, cab, and/or trunk/truck bed can be mounted onto maglev units. The magnets utilized for the engine (and transaxle/transmission) can measure approximately three inches by two inches by one inch in certain exemplary embodiments, and can have a push-pull capacity of approximately 430 pounds.

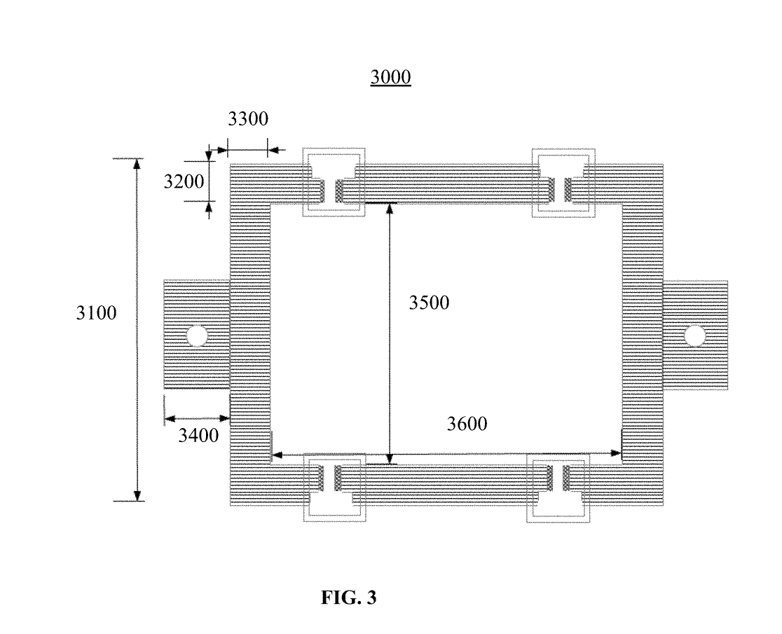

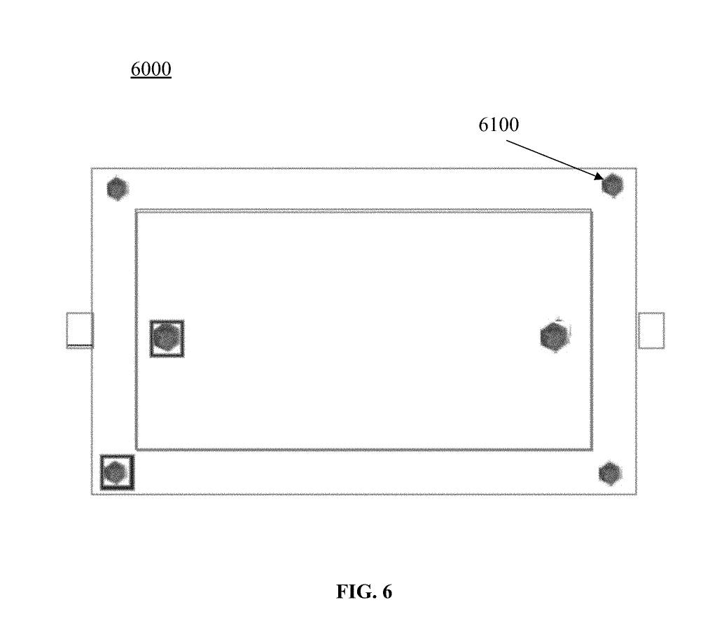

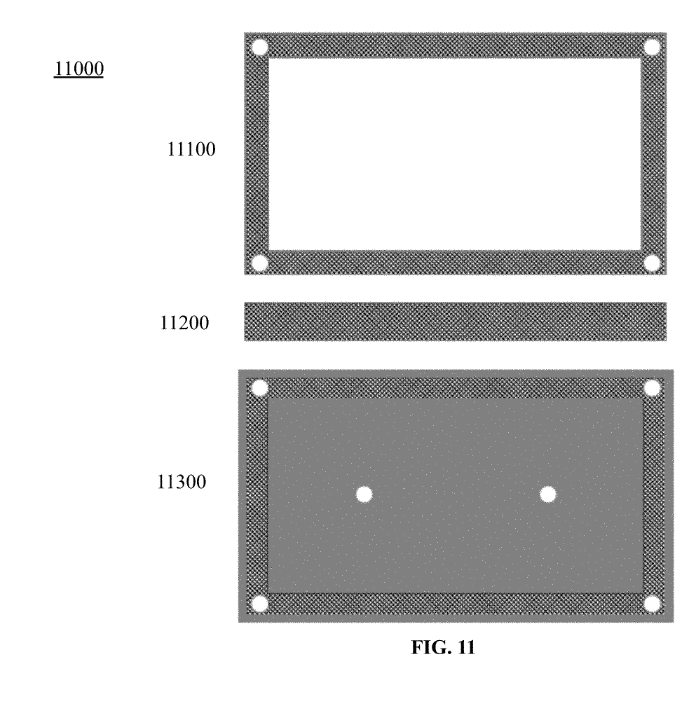

In certain exemplary embodiments, a pair of neodymium magnets is placed in individual Load Containers (See FIGS. 6-10 and FIG. 12) with the positive poles facing up, exposed through an open Container Lid (FIG. 11). The Type 1 Load Container is inserted into a Cage (FIGS. 3-5) with the Container Lid in the center of the Cage. In certain exemplary embodiments, a Type 3 Load Container is inserted, with the Container Lid facing the Type 1 Load Container in center of the Cage. Since both (positive) poles are facing each other, physical contact between the containers should be avoided.

Incorporating exemplary embodiments will cause automobile manufacturers and/or service personnel to modify engine blocks to accommodate connection points for a pedestal. In certain exemplary embodiments, support points for engine blocks can be near the corner of the block, near the oil pan mounts. Other modifications might include incorporating cross frame members to mount the passenger cab (between the rails under the front passenger seats) and the rear seats, and the trunk/truck bed. Certain exemplary embodiments can be designed to function as a supplemental engine workload system. Mounting components onto maglev units can reduce the workload of the engine by the weight associated with each component. By reducing the workload of the engine, the fuel efficiency and overall performance of a vehicle can be increased. Incorporating exemplary embodiments can enable manufacturers to reduce the costs associated with production by reducing the number of cylinders, without compromising the performance of their vehicles. Exemplary embodiments designed to support the passenger cabs and trunk/truck beds are slightly larger, with increased load capacities.

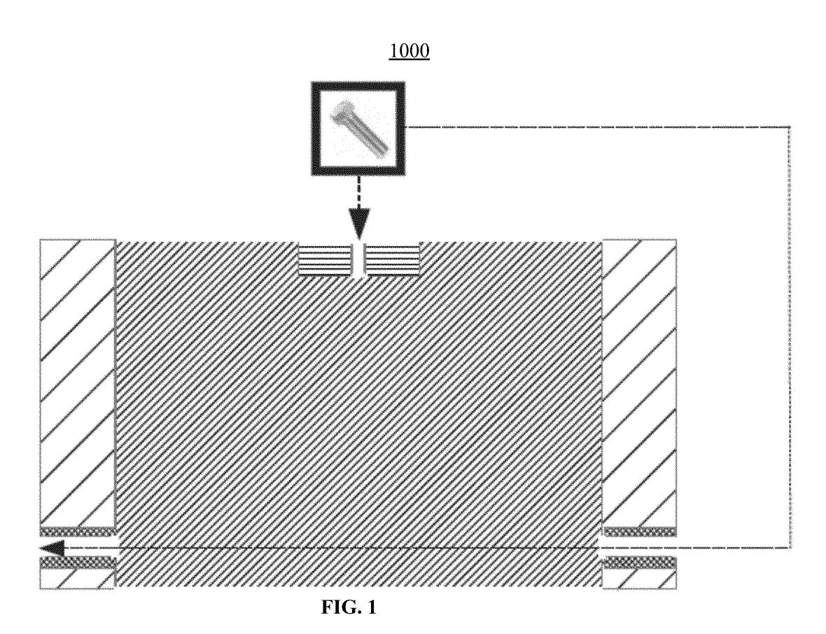

FIG. 1 is sectional cut-away end view of an exemplary embodiment of a system 1000. System 1000 can be constructed of galvanized steel (e.g., SAE 4150), with tapped bolt receptacle cavities formed at the bottom of both ends.

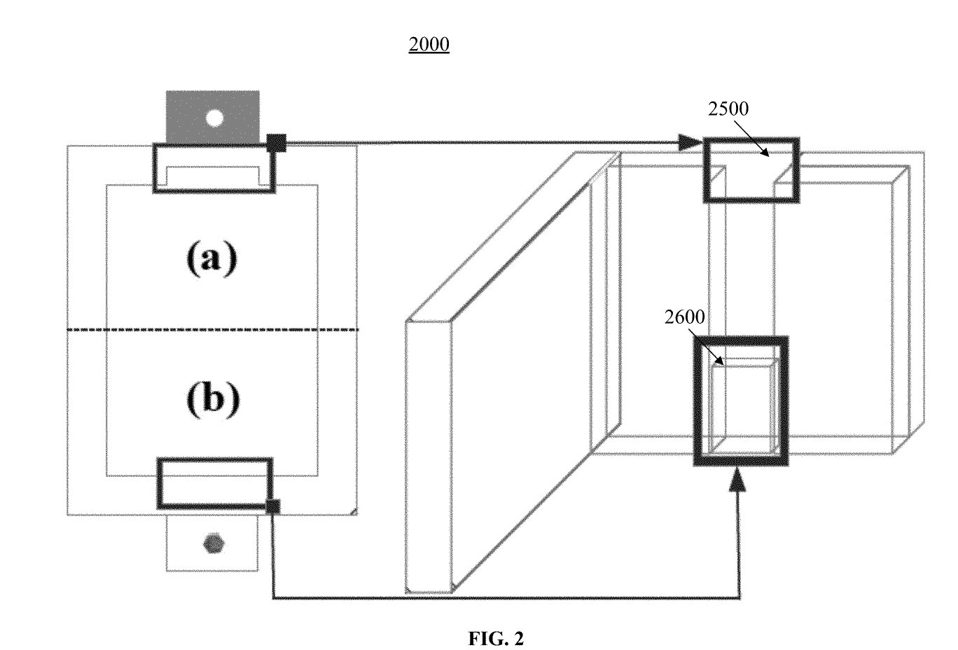

FIG. 2 is a pair of views of an exemplary embodiment of a system 2000. The view on the left of FIG. 2 is a constructional draft plan view of (a) bottom and (b) top. The view on the right of FIG. 2 is a sectional end view that illustrates a groove 2500 and a stop 2600. Bottom, left: the top half of the illustration depicts a slot incorporated to serve as a guide for the assembly, using a “tongue-and-groove” design. The bottom half depicts the termination of the slot, designed to restrain Type 1 Load Containers from leaving the Cage. The Cage is designed to permit a maximum predetermined gap (e.g., approximately 0.25 inches) between the top and bottom containers.

FIG. 3 is sectional view of an exemplary embodiment of a system 3000. System 3000 indicates possible dimensions for an exemplary engine unit prototype. Approximate dimensions can be as follows:
3100 can be, in inches, approximately: 3.5, 3.81, 3.75, 4.1, 4.333, 4.375, 4.6, 4.75, 5.01, 5.20, 5.31, 5.435, 5.5, 5.789, 6, 6.1, or 6.25;
3200 can be, in inches, approximately: 0.125, 0.24, 0.37, 0.40, 0.513, 0.617, 0.75, 0.9, or 1.02;
3300 can be, in inches, approximately: 0.132, 0.25, 0.294, 0.35, 0.40, 0.5, 0.734, 0.812, 0.93, or 1.113;
3400 can be, in inches, approximately: 0.24, 0.275, 0.328, 0.44, 0.50, 0.625, 0.712, 0.824, 0.912, 1, 1.125, or 1.217;
3500 can be, in inches, approximately: 2.0, 2.239, 2.841, 3.188, 3.46, 3.79, 4, 4.12, 4.27, 4.598, 4.793, 5.1, 5.7, 6.3, or 7.7; and
3600 can be, in inches, approximately: 3.2, 2.583, 3.293, 3.75, 4.312, 4.394, 4.756, 4.9, 5.02, 5.11, 5.6, 6.124, 6.598, 7.0, 7.209, 7.5, 8.125, 9.429, 9.5, or 10.123.

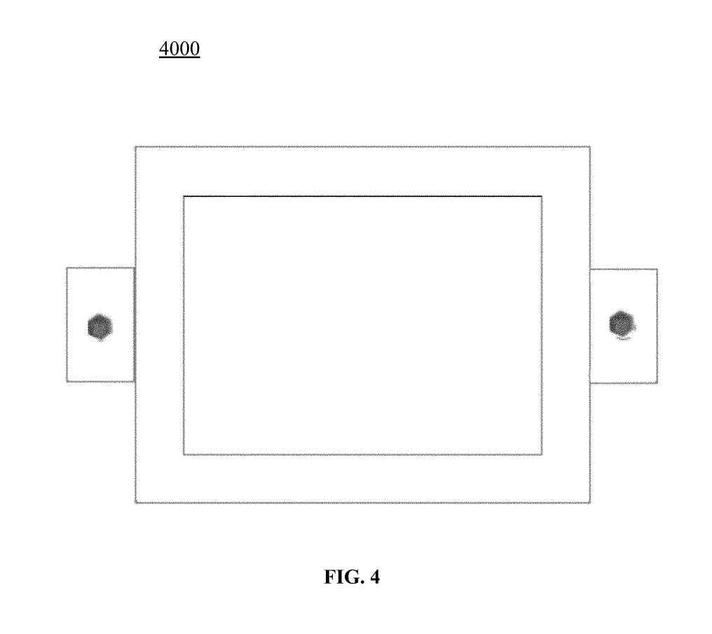

FIG. 4 is plan view of an exemplary embodiment of a system 4000, which shows a top right plan view of an exemplary cage.

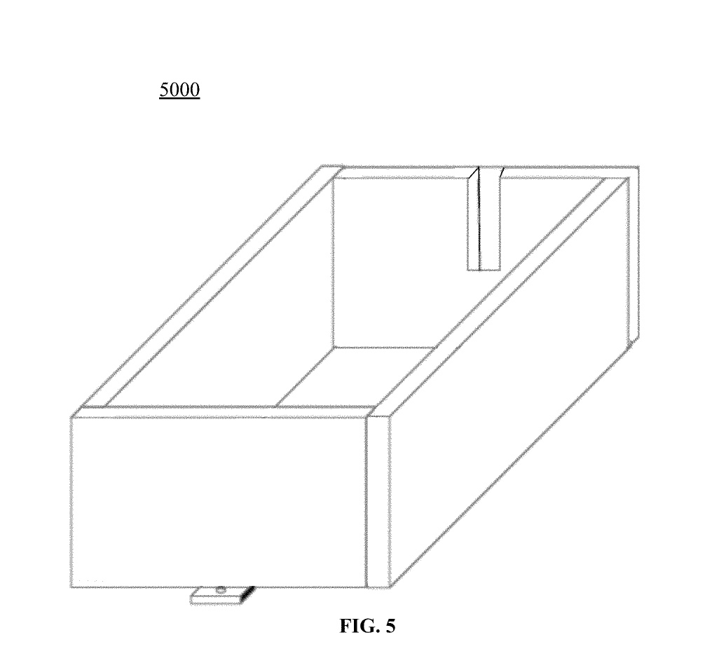

FIG. 5 is perspective view of an exemplary embodiment of a system 5000 illustrated as a semi-transparent cage positioned for unit assembly.

FIG. 6 is plan view of an exemplary embodiment 6000 of a load container Type 1.

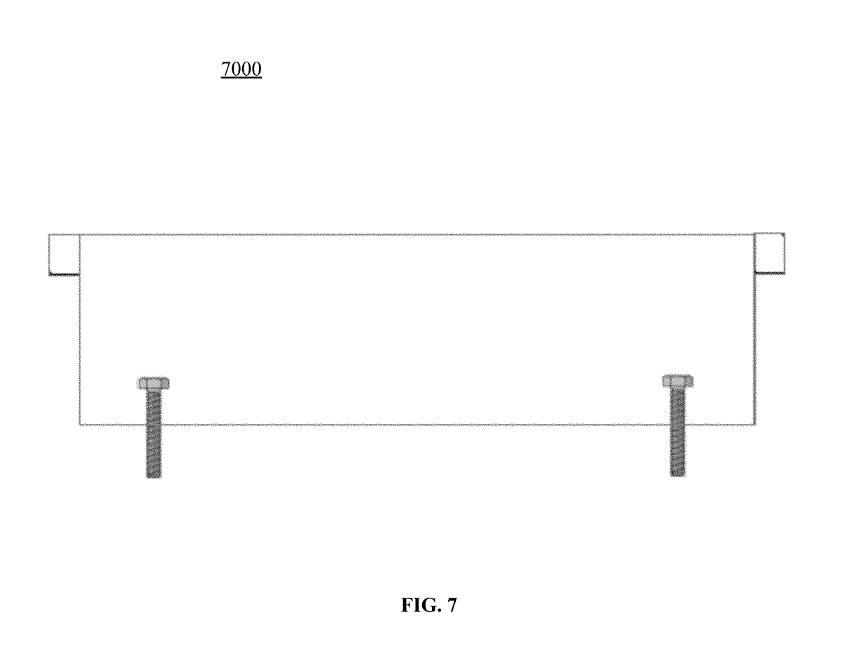

FIG. 7 is side view of an exemplary embodiment 7000 of a load container Type 1.

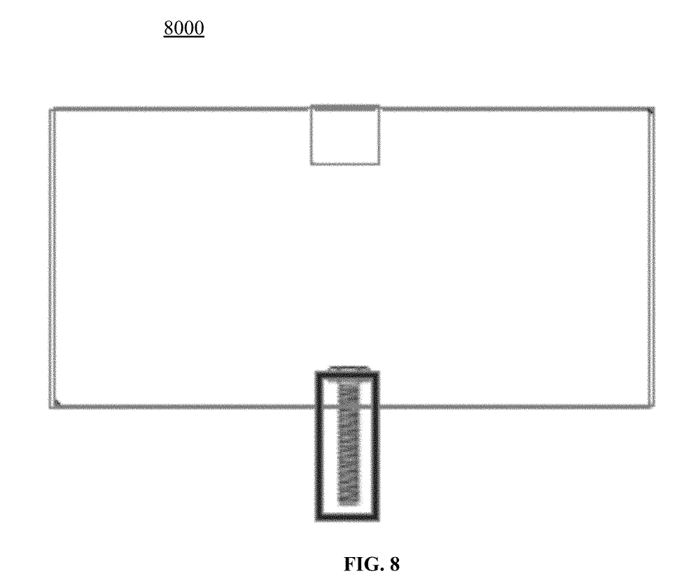

FIG. 8 is an end view of an exemplary embodiment 8000 of a load container Type 1.

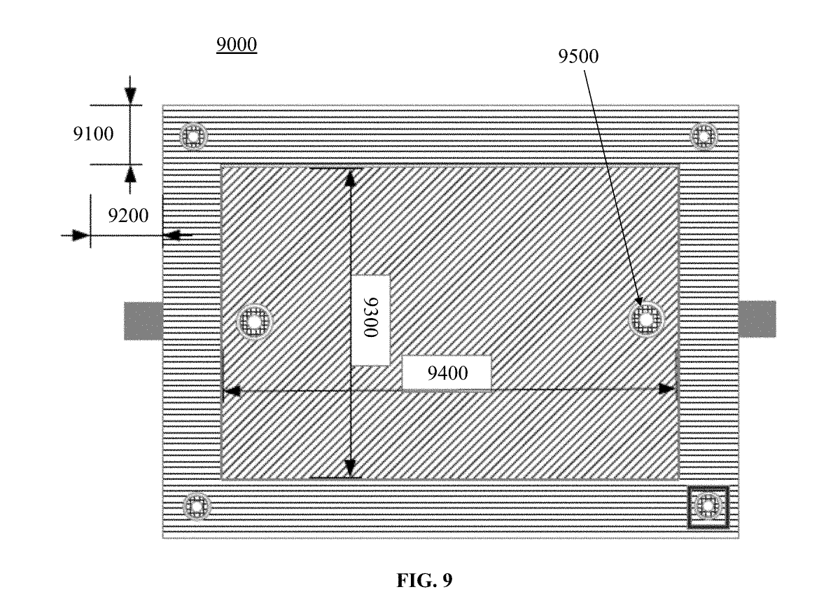

FIG. 9 is a sectional view of an exemplary embodiment 9000 of a load container Type 1, which illustrates certain dimensions. System 9000 illustrates a plurality of fasteners 9500. System 9000 indicates possible dimensions for an exemplary prototype. Approximate dimensions can be as follows:
9100 can be, in inches, approximately: 0.213, 0.25, 0.293, 0.31, 0.357, 0.39, 0.4, 0.441, 0.517, 0.625, 0.661, 0.99, or 1.124;
9200 can be, in inches, approximately: 0.21, 0.377, 0.441, 0.5, 0.677, 0.812, 0.999, or 1.125;
9300 can be, in inches, approximately: 1, 1.289, 1.375, 1.632, 1.999, 2, 2.12, 2.647, 2.911, 3.392, 3.499, 3.76, 4.077, 4.24; and
9400 can be, in inches, approximately: 1.45, 1.723, 1.911, 2.337, 2.465, 2.778, 3, 3.12, 3.476, 3.659, 4.109, 4.576, 5.111, 5.454, 6.653, or 6.245.

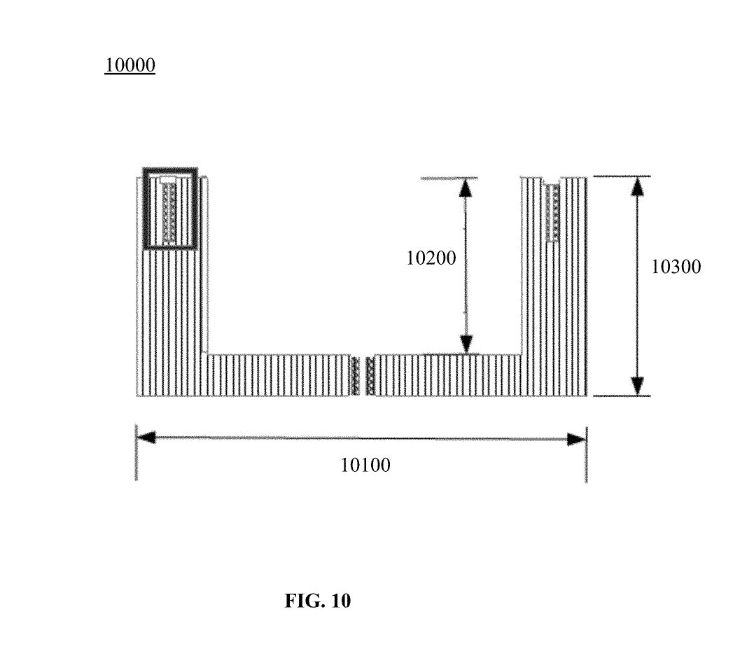

FIG. 10 is a sectional view of an exemplary embodiment 10000 of a load container Type 1, which illustrates certain dimensions. System 10000 indicates possible dimensions for an exemplary prototype. Approximate dimensions can be as follows:
10100 can be, in inches, approximately: 1.374, 1.692, 1.997, 2.125, 2.395, 3.761, 2.82, 3, 3.213, 3.3, 3.4, 3.876, 4.123, or 4.5;
10200 can be, in inches, approximately: 0.575, 0.719, 0.7932, 0.8371, 0.924, 1.011, 1.12, 1.259, 1.375, 1.441, 1.75, 1.991, or 2.034; and
10300 can be, in inches, approximately: 0.75, 0.811, 1.019, 1.297, 1.4, 1.591, 1.775, 2.1, 2.449, 2.7, or 2.999.

FIG. 11 shows three views of an exemplary embodiment 11000 of a container lid. The upper view 11100 is a plan view of container lid 11000. Container lid 11000 is constructed to fit on either a top or bottom of a load container. The center view 11200 is side view of container lid 11000. The bottom view 11300 is a plan view of container lid 11000 situated in an installed position on a bottom of a Type 1 Unit. The design of container lid 11000 enables relatively quick inspections and verification of container contents. Container Lid 11000 can be designed to fit either Type 1 or Type 3 Load Containers

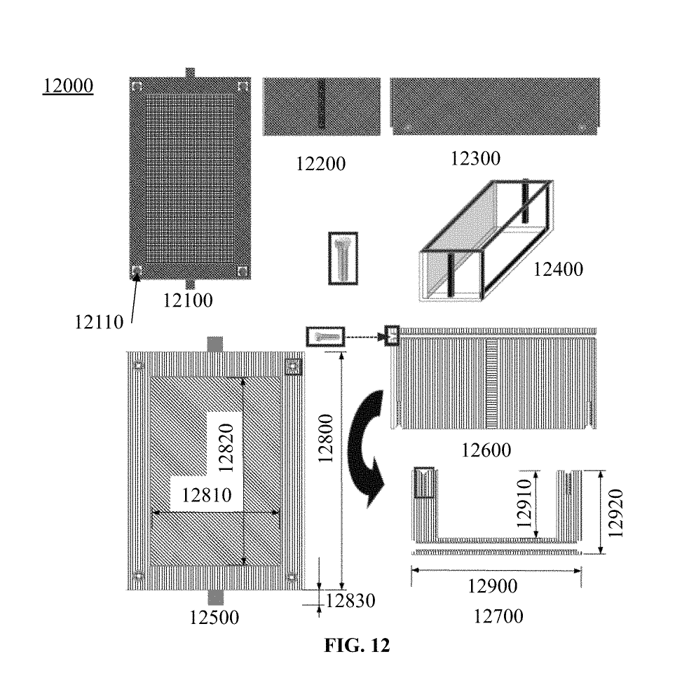

FIG. 12 is a set of seven views of an exemplary embodiment 12000 of a load container Type 3. View 12100 is a plan view. View 12200 is an end view. Guide tabs for Type 3 applications are longer than for Type 1 applications. View 12100 is a side view. Exemplary embodiment 12000 can define tapped and/or counter-sunken bolt receptacle cavities at the bottom ends. View 12400 shows a semi-transparent three-dimensional representation.

Each of view 12500, view 12600 and view 12700 are sectional views. View 12500 is a sectional plan view, which indicates possible dimensions for an exemplary prototype. Approximate dimensions can be as follows:
12800 can be, in inches, approximately: 2.23, 2.495, 2.994, 3.378, 3.96, 4.267, 4.587, 5.109, 5.5, 5.891, 6.222, 7, 485, 7.5, 7.771, 8.022, or 8.101;
12810 can be, in inches, approximately: 1.025, 1.375, 1.577, 1.85, 2.103, 2.12, 2.274, 2.599, 3.01, 3.5, 4.017, or 4.24;
12820 can be, in inches, approximately: 1.4, 1.596, 1.908, 2.390, 4.602, 3.12, 3.785, 4, 4.111, 4.577, 5.123, 5.456, 5.725, 5.997, 6.103, 6.257 6.5; and
12820 can be, in inches, approximately: 0.1, 0.122, 0.173, 0.247, 0.25. 0.272, 0.3, 0.411, 0.593, 0.652, or 0.673.

View 12600 is a sectional side view. View 12700 is a sectional end view, which indicates possible dimensions for an exemplary prototype. Approximate dimensions can be as follows:
12900 can be, in inches, approximately: 1.251, 1.375, 1.504, 1.898, 2.022, 2.475, 2.62, 3.994, 4.321, 4.8, 4.919, 5.124, 5.25, or 5.31;
12910 can be, in inches, approximately: 0.552, 0.621, 0.710, 0.937, 1.041, 1.12, 1.229, 1.5, 1.627, 1.994, 2.104, 2.288, or 2.431; and
12920 can be, in inches, approximately: 0.56, 0.671, 0.889, 1.027, 1.360, 1.4, 1.56, 1.887, 1.967, 2.281, 2.447, 2.587, 2.75, 2.884, or 2.99.

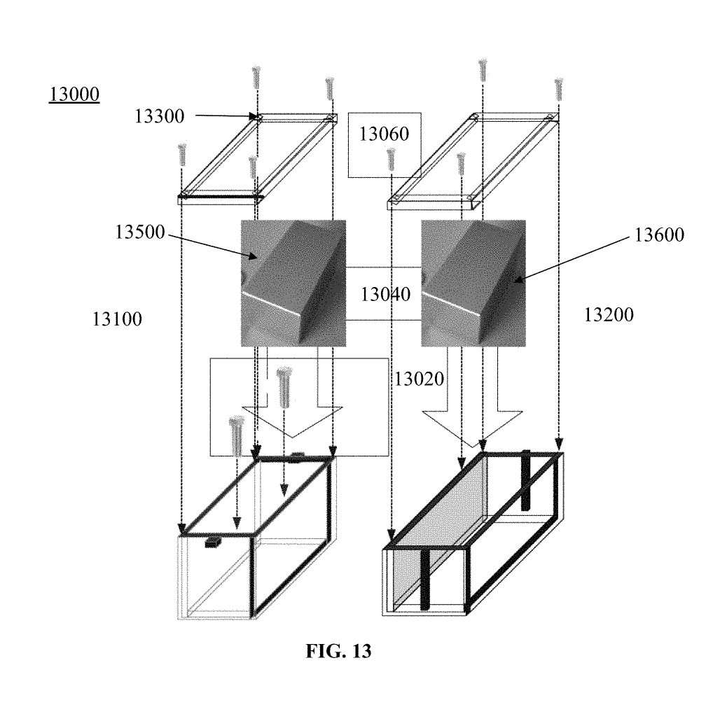

FIG. 13 is a pair of exploded views of an exemplary embodiment of container assemblies 13000. First exploded view 13100 is an exploded view of a Type 1 load container. Second exploded view 13200 is an exploded view of a Type 3 load container. Each of the pair of exploded views can be assembled via a first activity 13020, a second activity 13040, and a third activity 13060. Prior to a main assembly, unit assemblies can proceed. At first activity 13020, anchor bolts can be fastened through a bottom of an exemplary load container. At second activity 13040, a magnet can be placed inside of the container with a positive pole marker oriented in an upward direction. At third activity 13060, the container lid can be fastened in position.

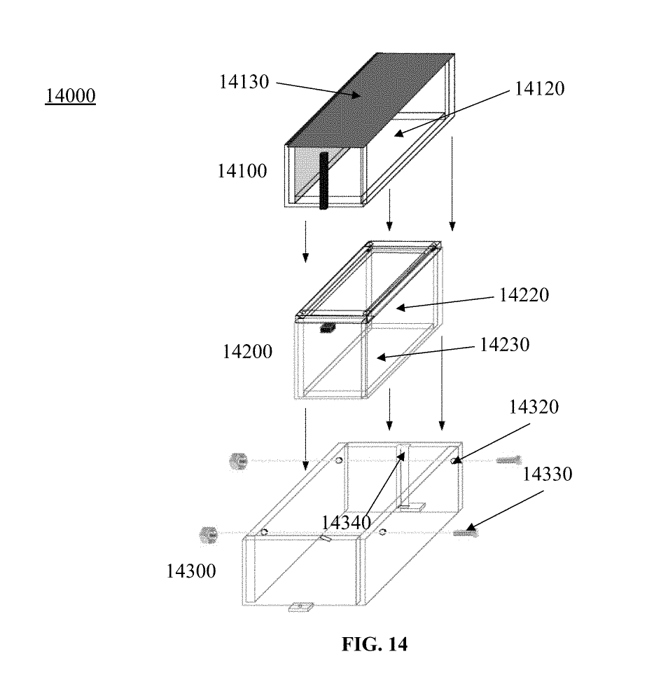

FIG. 14 is an exploded view of an exemplary embodiment of a container assembly 14000. A cage 14300 can be placed in a position to be coupled to load containers and magnets. A first load container 14200 (Type 1) can be inserted with anchor bolts towards the bottom, and the lid facing the center of cage 14300. A second load container 14100 (Type 3) can be inserted with the lid facing away from cage 14300. With a unit partially assembled, second load container 14100 can be placed inside a module comprising a hydraulic vise. The vise can be utilized to press container assembly 14000 into position; bolts and nuts can be used to secure the components of container assembly 14000 in place.

Certain exemplary systems comprise:
a first neodymium magnet (e.g., magnet 13500 of FIG. 13);
a second neodymium magnet (e.g., magnet 13600 of FIG. 13);
first load container 14200, which can comprise a plurality of anchor bolts (see, e.g., fasteners 6100 in FIG. 6); wherein first load container 14200 defines a first load container cavity 14220; wherein first load container cavity 14220 is constructed to receive and partially surround the first neodymium magnet, and first load container 14200 is constructed to restrain motion of the first neodymium magnet in two mutually perpendicular directions when the first neodymium magnet is placed in first load container cavity 14220;
a second load container 14100, which defines a second load container cavity 14120; wherein second load container cavity 14120 is constructed to receive and partially surround the second neodymium magnet, and second load container 14100 is constructed to restrain motion of second first neodymium magnet in two mutually perpendicular directions when the second neodymium magnet is placed in the second load container cavity;
a cage 14300, cage 14300 defining a plurality of apertures 14320, wherein plurality of apertures 14320 are constructed to receive plurality of anchor bolts 14330 of the first load container and thereby releasably couple first load container 14200 to cage 14300, wherein cage 14300 is constructed to receive second load container 14100, wherein, when the a positive pole of the first neodymium magnet is placed facing a positive pole of the second neodymium magnet, and second load container 14100 is suspended above the first load container via magnetic repulsion; wherein second load container 14100 is coupled to cage 14300 via a plurality of fasteners (see, e.g., fasteners 12110 of FIG. 12);
a vehicle coupleable to cage 14300, wherein an engine, cab, truck, or truck bed of the vehicle is supported by the magnetic repulsion;
a first load container lid 14230 coupleable to first load container 14200, wherein first load container lid 14230 defines an aperture (see, e.g., aperture 13300 of FIG. 13);
a second load container lid 14130 coupleable to second load container 14100.

Certain exemplary embodiments utilize magnetic repulsion to support an engine of vehicle. In such applications, cage 14300 is coupled to an engine block near oil pan mounts of the vehicle. Cage 14300 defines a pair of grooves 14340 that receive tongues of first load container 14200 and second load container 14100 when first load container 14200 and second load container 1400 are coupled to cage 14300.

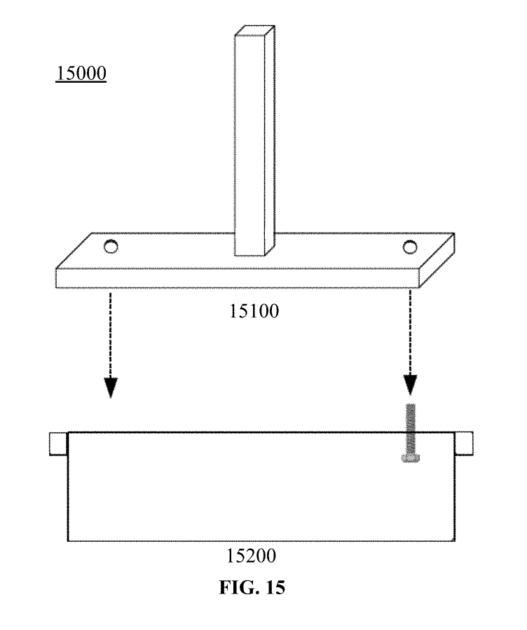

FIG. 15 is a pair of views of an exemplary embodiment of a system 15000, which comprises a pedestal 15100 and a base 15200. Pedestal 15100 is designed to mount an engine, and is fastened onto Type 1 anchor bolts. A Type 1 anchor bolt assembly design can be used for mounting a passenger cab, and/or trunk/truck bed.

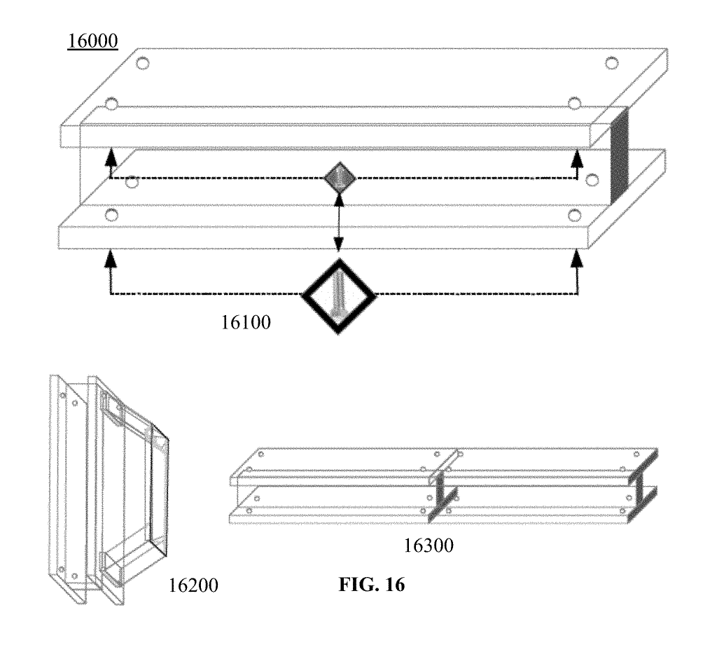

FIG. 16 is a set of three views of an exemplary embodiment of an aviation deck base mount 16000. Certain exemplary embodiments can be used to mount vehicle components and/or other practical applications. Aviation deck base mount 16000 can be designed for aircraft decks. Certain exemplary embodiments incorporate magnets with increased push-pull capacities, and grouped in pairs/fours for each mounting unit. Exemplary multi-purpose load bearing systems can be fastened onto the bottom of aviation deck base mount 16000, and bolts fastened through the top are designed to accommodate deck sections. View 16200 depicts the application of an exemplary multi-purpose load bearing system providing lateral support for deck units during aircraft roll and banking. Other aircraft applications can include fuel tank mounting and/or pylon mounting.

Additional applications envisioned for exemplary multi-purpose load bearing systems can comprise military aircraft and/or naval vessel augmentation.

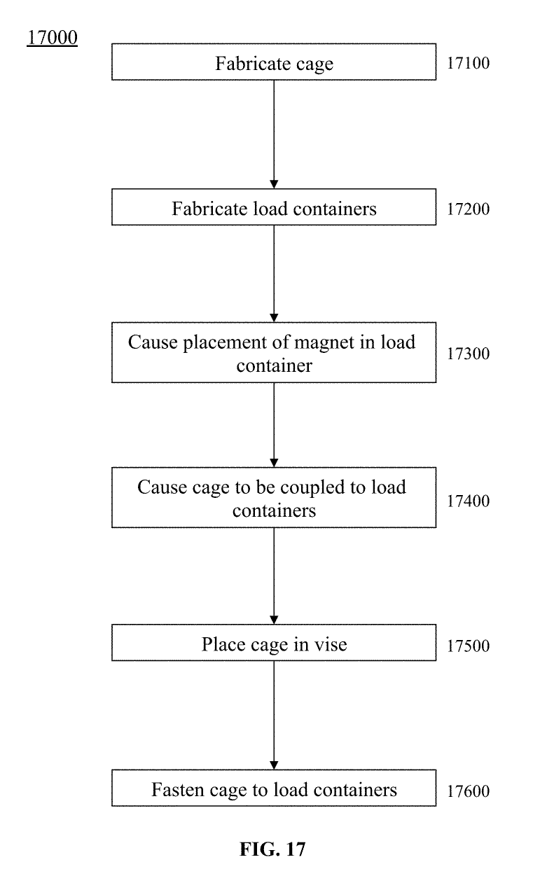

FIG. 17 is a flowchart of an exemplary embodiment of a method 17000. At activity 17100, a cage can be fabricated. At activity 17200, load containers can be fabricated. At activity 17300, magnets (e.g., neodymium magnets) are caused to be placed in the load containers. For example, the first neodymium magnet can be caused to be placed in the first load container.

At activity 17400, a cage is caused to be coupled to the load containers. The cage can be coupled to a first load container and a second load container. The first load container can comprise a first neodymium magnet. The second load container can comprise a second neodymium magnet. Magnetic repulsion of the first neodymium magnet and the second neodymium magnet maintains a separation between the first load container and the second load container. The cage can be coupleable to a vehicle. At activity 17500, the cage can be placed in a vise. At activity 17600, the cage can be fastened to the load containers via a plurality of fasteners.

In certain exemplary embodiments, the vehicle can be an airplane. In certain exemplary embodiments, the vehicle can be an aircraft carrier.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
aircraft carrier—a ship comprising a deck upon which planes can land.
airplane—a flying machine kept aloft by the upward thrust exerted by the passing air on its fixed wings and driven by propellers and/or jet propulsion, etc.
anchor bolt—a threaded fastener used to couple objects.
and/or—either in conjunction with or in alternative to.
aperture—an opening.
apparatus—an appliance or device for a particular purpose
associate—to join, connect together, and/or relate.
bed—a vehicle component that is used for carrying cargo.
cab—a covered or enclosed part of a vehicle in which one or more humans are housed when in the vehicle.
cage—a structure constructed to receive a pair of load containers.
can—is capable of, in at least some embodiments.
cause—to produce an effect.
cavity—a hollow space within an object.
comprising—including but not limited to.
configure—to make suitable or fit for a specific use or situation.
connect—to join or fasten together.
constructed to—made to and/or designed to.
convert—to transform, adapt, and/or change.
coupleable—capable of being joined, connected, and/or linked together.
coupling—linking in some fashion.
create—to bring into being.
define—to establish the outline, form, or structure of
device—a machine, manufacture, and/or collection thereof.
engine—a machine that converts a form of energy into mechanical energy or power to produce force and motion.
engine block—an integrated structure comprising one or more cylinders of a reciprocating engine and often some or all of their associated surrounding structures (e.g., coolant passages, intake and exhaust passages and ports, and crankcase).
face—to have a front toward or in a direction of.
fastener—one (or more) restraints that attach to, extend through, penetrate, and/or hold something. For example, a fastener can be one (or more) bolt and nut assembly, rivet, weldment, nail, screw, peg, staple, clip, buckle, clasp, clamp, hook and loop assembly, adhesive, and/or plastic push rivet, etc.
generate—to create, produce, give rise to, and/or bring into existence.
groove—a cut or indentation in a surface that is constructed to receive the tongue of another object.
install—to connect or set in position and prepare for use.
lid—a cover that is placed over an opening.
load container—a structure constructed to house a neodymium magnet.
magnetic repulsion—an force that substantially prevents poles of two magnets having a same polarity from contacting each other.
may—is allowed and/or permitted to, in at least some embodiments.
method—a process, procedure, and/or collection of related activities for accomplishing something.
motion—a change of position in space of an object.
mutually—of or relating to each of two or more.
neodymium magnet—a permanent magnet made from an alloy of neodymium, iron and boron to form the Nd₂Fe₁₄B tetragonal crystalline structure.
oil pan mount—a flange constructed to couple an oil pan to an engine.
partially surround—to enclose on one or more sides, but not on all sides.
perpendicular—meeting a given line or surface substantially at right angles.
place—to put in a location.
plurality—the state of being plural and/or more than one.
positive pole—an edge of a magnet that points northward when the magnet is suspended freely.
predetermined—established in advance.
provide—to furnish, supply, give, and/or make available.
receive—to get, take, acquire, and/or obtain.
releasably—capable of being decoupled in a substantially nondestructible manner.
restrain—to limit motion of an object.
select—to make a choice or selection from alternatives.
separation—a gap between to object surfaces.
set—a related plurality.
store—to place, hold, and/or retain.
substantially—to a great extent or degree.
suspend—to hang from above something.
support—to bear the weight of, especially from below.
system—a collection of mechanisms, devices, machines, articles of manufacture, processes, data, and/or instructions, the collection designed to perform one or more specific functions.
tongue—a projection from a surface that is constructed to engage with a groove to couple an object comprising the projection to an object defining a groove.
vehicle—any means in or by which something is carried or conveyed, such as, for example, an automobile, a pick-up truck, a truck, an airplane, a boat, a ship, a motorcycle.
via—by way of and/or utilizing.
vise—any of various devices, usually having two jaws that may be brought together or separated by means of a screw, lever, or the like, used to hold an object firmly while work is being done on it.
weight—a value indicative of importance.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A system comprising:
a first neodymium magnet;
a second neodymium magnet;
a first load container, said first load container comprising a plurality of anchor bolts, said first load container defining a first load container cavity, said first load container cavity constructed to receive and partially surround said first neodymium magnet, said first load container constructed to restrain motion of said first neodymium magnet in two mutually perpendicular directions when said first neodymium magnet is placed in said first load container cavity;
a second load container, said second load container defining a second load container cavity, said second load container cavity constructed to receive and partially surround said second neodymium magnet, said second load container constructed to restrain motion of second first neodymium magnet in two mutually perpendicular directions when said second neodymium magnet is placed in said second load container cavity;
a first cage, said first cage defining a plurality of apertures, wherein said plurality of apertures are constructed to receive said plurality of anchor bolts of said first load container and thereby releasably couple said first load container to said first cage, said cage constructed to receive said second load container, wherein, when said a positive pole of said first neodymium magnet is placed facing a positive pole of said second neodymium magnet, said second load container is suspended above said first load container via magnetic repulsion; and
a vehicle coupleable to said first cage, wherein an engine, cab, truck, or truck bed of said vehicle is supported by said magnetic repulsion.

2. The system of claim 1, further comprising:
a first load container lid, said first load container lid coupleable to said first load container, wherein said first load container lid defines an aperture.

3. The system of claim 1, further comprising:
a second load container lid, said second load container lid coupleable to said second load container.

4. The system of claim 1, wherein:
said second load container is coupled to said cage via a plurality of fasteners.

5. The system of claim 1, wherein:
said magnetic repulsion supports said engine of said vehicle.

6. The system of claim 1, wherein:
said cage is coupled to an engine block near oil pan mounts of the vehicle.

7. The system of claim 1, wherein:
said cage defines a pair of grooves that receive tongues of said first load container and said second load container when said first load container and said second load container are coupled to said cage.

8. A method comprising:
causing a cage to be coupled to a first load container and a second load container, said first load container comprising a first neodymium magnet, said second load container comprising a second neodymium magnet, wherein magnetic repulsion of said first neodymium magnet and said second neodymium magnet maintain a separation between said first load container and said second load container, wherein said cage is coupleable to a vehicle.

9. The method of claim 8, further comprising:
causing placement of said first neodymium magnet in said first load container.

10. The method of claim 8, further comprising:
placing said cage in a vise to couple said second load container to said cage via a plurality of fasteners.

11. The method of claim 8, wherein:
said vehicle is an airplane.

12. The method of claim 8, wherein:
said vehicle is an aircraft carrier.
